(19) United States
(12) Patent Application Publication
(10) Pub. No.: US 2013/0160719 A1
(43) Pub. Date: Jun. 27, 2013

(54) Rigid Pet Leash

(71) Applicants: Lawrence Scott Trombley, Trenton, MI (US); Kathleen Trombley, Weeki Wachee, FL (US)

(72) Inventors: Lawrence Scott Trombley, Trenton, MI (US); Kathleen Trombley, Weeki Wachee, FL (US)

(21) Appl. No.: 13/335,553

(22) Filed: Dec. 22, 2011

(51) Int. Cl. A01K 27/00

(52) U.S. Cl. 119/796; 119/799

(57) ABSTRACT

A rigid pet leash includes a tubular body member defining an interior area. A first extension rod is situated in the interior area and movable between a retracted configuration inside the interior area and an extended configuration outside the interior area, the first extension rod second end defining an outlet. A locking mechanism is adjacent the body member second end and configured to selectively hold the first extension rod at the retracted or extended configuration. A retractable reel is positioned in the body member interior area and configured for rotatable movement. A flexible leash is wound about the reel and extends through the interior area and through the first extension rod outlet. A tension adjustment mechanism is situated on the body member in operative communication with the leash within the body member configured to selectively increase a tension on the leash when the leash is unwound from the reel.

### BACKGROUND OF THE INVENTION

This invention relates generally to pet restraint devices and, more particularly, to a pet leash having a substantially rigid configuration so as not to become entangled around a pet or a pet owner in the course of walking the pet.

Many pet owners living in urban and suburban areas routinely take their dogs for a walk one or more times a day using a leash of some kind so as to maintain guidance and control of their dog. Traditionally, a pet leash includes a flexible cord held at one end by a pet owner and connected at the opposite end to a pet's collar. A recurrent problem with traditional dog leashes is that they allow an energetic dog to run circles around the owner causing the leash to become entangled around the owner's legs and creating a trip hazard.

Various devices have been proposed in the art for improving the traditional pet leash, such as a leash extending from a retractable reel that enables the length of the leash to be adjusted or to automatically retract. Although assumably effective, the leash reel may not allow the leash to be automatically withdrawn which causes the dog to be suddenly restrained if he runs forward too far and causes the pet owner to be jerked forward with equal force. In addition, the extended leash may still become entangled about the legs and feet of the person walking the dog.

Therefore, it would be desirable to have a rigid pet leash that includes a length adjustable body member having a rigid construction that does not allow a dog to wrap the leash around a pet owner's legs. Further, it would be desirable to have a rigid pet leash that selectively allows a flexible leash to be extended from a distal end of the rigid body member. In addition, it would be desirable to have a rigid pet leash having a leash tension adjustment mechanism that enables a flexible leash to be extended from the rigid body member but extended with a selectably adjustable resistance.

### SUMMARY OF THE INVENTION

A rigid pet leash includes a tubular body member defining an interior area. A tubular first extension rod is situated in the interior area and movable through the body member second end between a retracted configuration substantially inside the interior area and an extended configuration substantially outside the interior area, the first extension rod second end defining an outlet. A locking mechanism is adjacent the body member second end configured to selectively hold the first extension rod at the retracted or extended configuration. A retractable reel is positioned in the body member interior area and configured for rotatable movement. A flexible leash is wound about the reel and extends through the interior area and through the first extension rod outlet. A tension adjustment mechanism is situated on the body member in operative communication with the leash within the body member configured to selectively increase a tension on the leash when the leash is unwound from the reel. In some embodiments, a second extension rod is situated in the first extension rod and movable between retracted and extended configurations, the flexible leash extending through and out of a distal end of the second extension rod.

Therefore, a general object of this invention is to provide a pet leash having a rigid body member that can not become entangled about the legs or feet of a pet owner walking a dog.

Another object of this invention is to provide a pet leash, as aforesaid, in which the body member has a telescopic construction such that the length may selectively be extended.

Still another object of this invention is to provide a pet leash, as aforesaid, which includes a flexible leash selectively extendable from the body member so as to give a pet a degree of flexible movement.

Yet another object of this invention is to provide a pet leash, as aforesaid, that includes a tension adjustment mechanism that, in cooperation with a leash reel, allows the flexible leash to be extended under a selected degree of tension.

A further object of this invention is to provide a pet leash, as aforesaid, that is easy to use.

A still further object of this invention is to provide a pet leash, as aforesaid, in which the flexible leash may be retracted about a reel using a rotatable dial.

Another object of this invention is to provide a pet leash, as aforesaid, in which the tension adjustment mechanism is selectably adjusted using a rotatable dial.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a rigid pet leash according to a preferred embodiment of the present invention with a body member in a retracted configuration;

FIG. 2 is a perspective view of the rigid pet leash as in FIG. 1 with the body member in an extended configuration;

FIG. 3 is another perspective view of the rigid pet leash as in FIG. 1 on an enlarged scale;

FIG. 4a is a top view of the rigid pet leash as in FIG. 1;

FIG. 4b is a sectional view taken along line 4b-4b of FIG. 4a;

FIG. 4c is an isolated view on an enlarged scale taken from FIG. 4b illustrating a tension adjusting mechanism in a released configuration;

FIG. 5a is a top view of the rigid pet leash as in FIG. 1;

FIG. 5b is a sectional view taken along line 5b-5b of FIG. 5a;

FIG. 5c is an isolated view on an enlarged scale taken from FIG. 5b illustrating a tension adjusting mechanism in a tightened configuration;

FIG. 6a is a bottom view of the rigid pet leash as in FIG. 1; and

FIG. 6b is a sectional view taken along line 6b-6b of FIG. 6a.

### DESCRIPTION OF THE PREFERRED EMBODIMENT

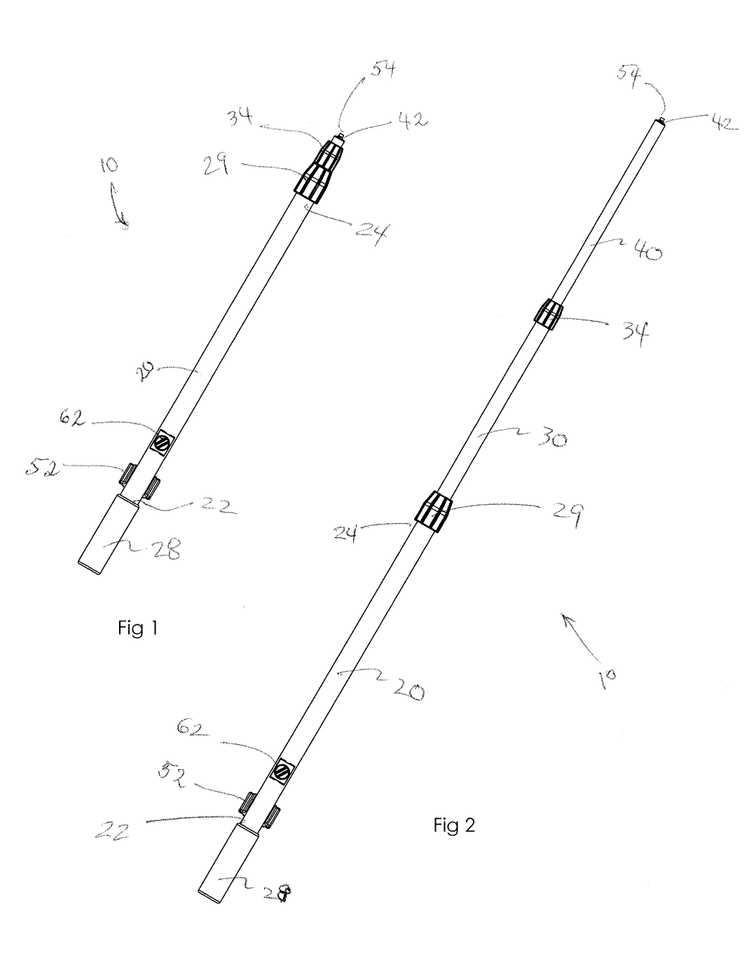

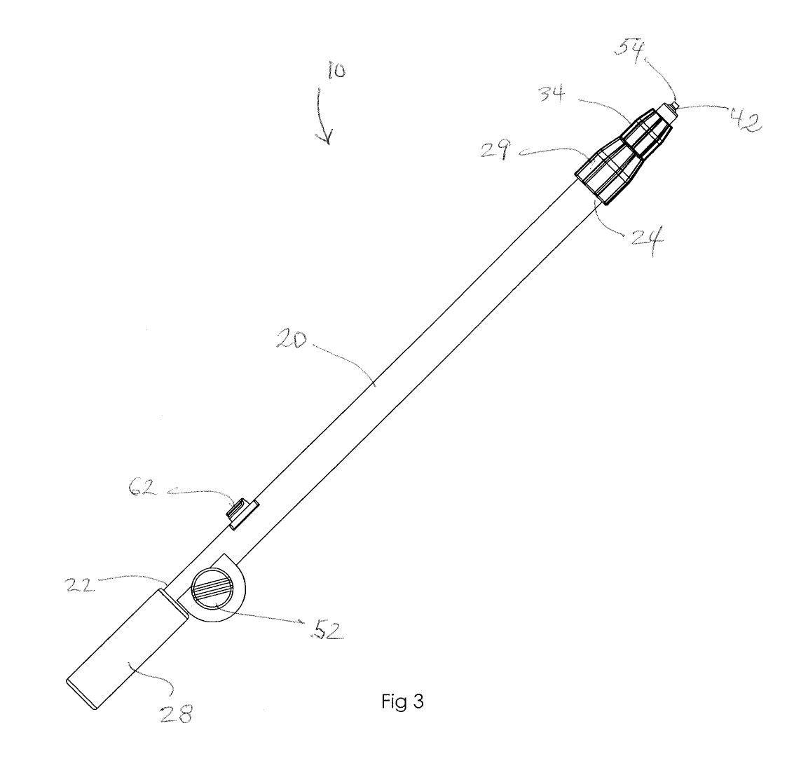

A rigid pet leash according to a preferred embodiment of the present invention will be described in detail with reference to FIGS. 1 to 6b of the accompanying drawings. The rigid pet leash 10 includes a body member 20, at least a first extension rod 30, a reel 50, a flexible leash 54, and a tension adjustment mechanism 60.

The body member 20 includes opposed first 22 and second 24 ends, the second end 24 having an open configuration. The body member 20 includes a durable, rigid construction that is substantially inflexible. The body member 20 has a tubular configuration that defines an interior area. A handle 28 may be coupled to the first end 22 of the body member 20. The handle 28 is configured to be comfortable and securely held by a user when using this invention.

The first extension rod 30 may include a tubular construction that is diametrically smaller than the body member 20 and is situated within the body member interior area. The first extension rod 30 is selectively movable between a retracted configuration substantially within the body member interior area (FIG. 1) and an extended configuration substantially outside of the interior area (FIG. 2). The body member 20 may include a stop (not shown) adjacent the second end 24 configured to prevent the first extension rod 30 from being completely removed from the interior area. Alternatively, the first extension rod 30 may itself include a stop configured to prevent removal. The first extension rod 30 defines an outlet 32 at a distal end thereof through which the flexible leash 54 may extend as will be described in more detail later.

A locking mechanism 29 may be coupled to the second end 24 of the body member 20, the locking mechanism 29 being configured to contact both the body member 20 and an outer surface of the first extension rod 30 when the first extension rod 30 is extended from the body member interior area. Preferably, the locking mechanism 29 is a rotatable friction clamp such that rotation thereof in one direction tightens the first extension rod 30 against slidable movement relative to the body member 20 and movement in another direction releases the first extension rod 30 to move relative to the body member 20, such as to return from the extended configuration to the retracted configuration. It is understood that the first extension rod 30 may be secured at points intermediate the retracted and extended configurations using the locking device 29. Alternatively, the body member 20 and first extension rod 30 may include a spring-loaded pin and aperture combination (not shown).

In some embodiments, the rigid pet leash 10 may include a rigid second extension rod 40 that is movable through the outlet 32 of the first extension rod 30 between a retracted configuration substantially inside the first extension rod 30 and an extended configuration substantially outside the first extension rod 30. The second extension rod 40 may include a distal end defining an outlet 42. The second extension rod 40 includes a rigid construction and a tubular construction diametrically smaller than the first extension rod 30.

An auxiliary locking mechanism 34 may be positioned adjacent the first extension rod distal end and configured to selectively hold the second extension rod 40 at the retracted or extended configuration in a manner similar to that described above with respect to the body member 20 and first extension rod 30. It is understood that the second extension rod 40 may be secured at points intermediate the retracted and extended configurations. Therefore, the extension rods are telescopically coupled together and relative to the body member 20.

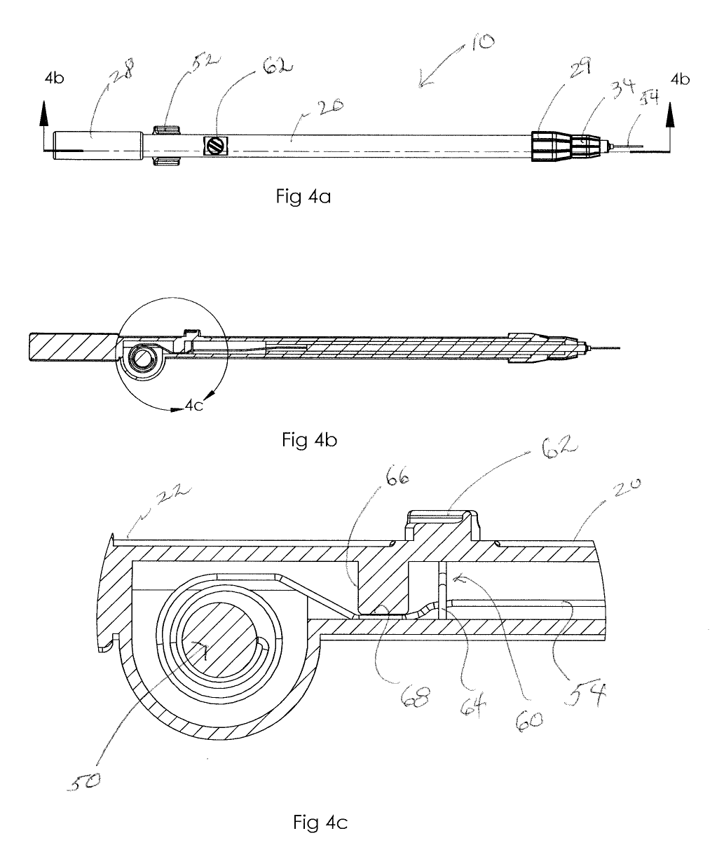

The reel 50 is positioned in the body member 20 adjacent the first end 22 of the body member 20. The reel 50 is mounted so as to rotate in the manner of a spool, such as being mounted on an axle. Specifically, the flexible leash 54 may be wound about the reel 50 with one end of the flexible leash 54 being fixedly attached to the reel 50 to prevent the flexible leash 54 from ever being totally withdrawn from the reel 50 as shown in FIG. 4c. The flexible leash 54 may extend from the reel 50 through the body member interior area, through the interior of the first extension member 30 and out through the outlet 32. In embodiments having a second extension rod 40, the flexible leash 54 may extend on through the second extension rod 40 and out through its outlet 42. The flexible leash 54 may be a nylon cord although a light metal cable or other suitable material may also be suitable.

A retraction input 52 may be positioned on the exterior surface of the body member 20 and be in operative communication with the reel 50 so as to retract the flexible leash 54 back onto the reel 50 following its extension therefrom. The retraction input 52 may be rotary dial situated on an exterior surface of the body member and configured to cause the reel to rewind the flexible leash 54 upon its manual actuation by a user. Alternatively, automatic retraction means, such as spring-biased reel assembly may be incorporated in some embodiments (not shown).

The tension adjustment mechanism 60 according to a preferred embodiment may include a tension adjustment mechanism situated in the body member interior area that is in operative communication with the flexible leash 54 that extends through the interior area. The tension adjustment mechanism 60 is configured to selectively increase a tension on the flexible leash 54 or to decrease a tension thereon that is experienced when the flexible leash 54 is extended from the interior area as will be further described below. A tension adjustment input 62 is positioned on an exterior surface of the body member 20 and is configured to cause the tension adjustment mechanism to increase or decrease the tension upon the flexible leash 54 when actuated by a user. The tension adjustment mechanism input 62 may be a rotary dial configured such that a respective rotation of the dial causes respective linear movement of a retaining member 64 between tightened and released configurations as described below.

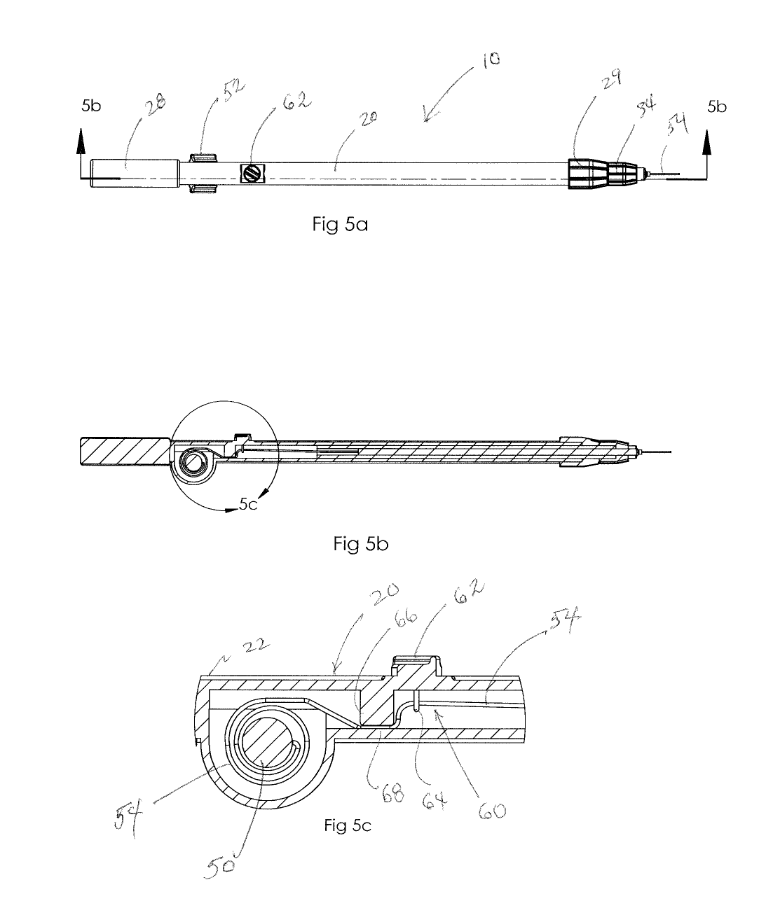

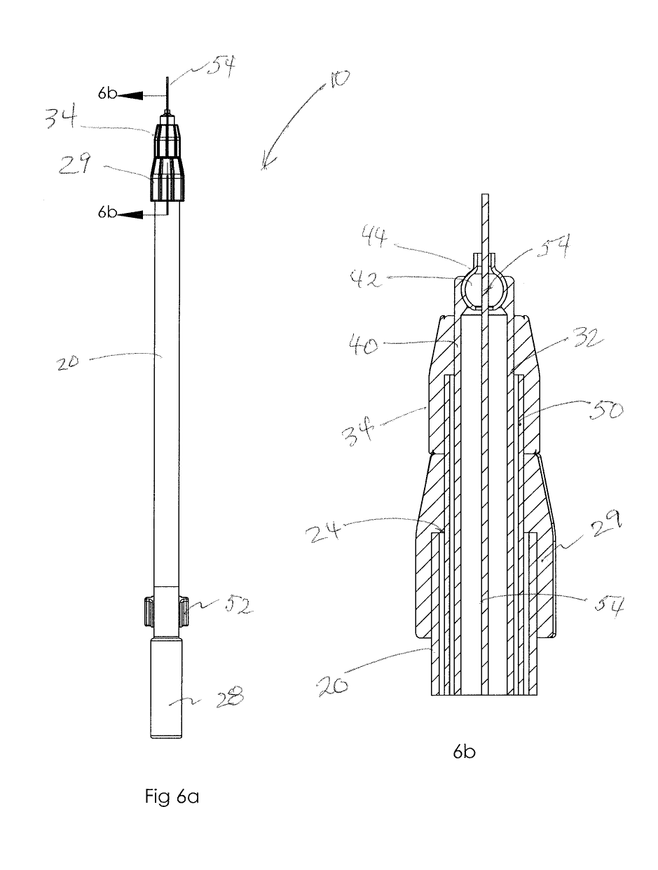

More particularly, the tension adjustment mechanism 60 includes a retaining member 64 coupled to the tension mechanism input and configured to extend into said body member interior space. The retaining member 64 is operatively coupled to the flexible leash 54 in that the flexible leash 54 may pass over or through the retaining member 64. Even more specifically, the retaining member 64 may include a loop or hook. Accordingly, movement of the tension adjustment input 62 to a first configuration (i.e. a “first position”) causes the retaining member 64 to move upwardly to a tightened configuration (FIG. 5c) at which the leash is biased away from a linear or relaxed configuration. A movement of the tension adjustment input 62 to a second configuration (i.e. a “second position”) causes the retaining member 64 to move downwardly to a released configuration at which the flexible leash 54 is returned to an unbiased linear configuration (FIG. 4c).

The increase in tension stated above is accomplished by the configuration of the interior of the body member 20. The body member 20 includes a wall 66 positioned in the interior area between the reel 50 and the retaining member 64 (FIG. 4a). The wall 66 defines a bore 68 extending longitudinally therethrough. Preferably, the bore 68 is situated adjacent to a bottom extent of an inner surface of the body member 20. The flexible leash 54 extends through the bore 68. In other words, the flexible leash 54 extends from the reel 50 through the bore 68 and through the retaining member 64 as best shown in FIGS. 4c and 5c. The bore 68 includes dimensions such that the flexible leash 54 is in frictional contact with either a lower extent of the wall 66, the inner surface of the body member 20, or both.

It is understood that when the retaining member 64 is actuated by the tension adjustment input 62 to move upwardly to the tightened configuration (FIG. 5c), the friction between the flexible leash 54 and the wall 66 at the forward end of the bore 68 is increased, thus making it more difficult to extend the flexible leash 54 away from the reel 50. When the retaining member 64 is actuated to move downwardly to the released configuration (FIG. 4c), the friction between the flexible leash 54 and the wall 66 is decreased, making it easier to extend the flexible leash 54 away from the reel 50.

As shown in FIG. 6b, a ball joint 44 may be positioned in the outlet 42 defined by the distal end of the second extension rod 40. It is understood that the ball joint may alternatively be positioned at the outlet defined by the first extension rod 30 in embodiments having only a single extension rod. The ball joint 44 enables the flexible leash 54 passing therethrough to swivel side to side, such as by movement of a dog moving from side to side.

In use, a user may extend the flexible leash 54 from the distal end of the second extension rod 40 and coupled to its terminal end (not shown) to the collar of a pet, such as a dog. The first 30 and second 40 extension rods may also be telescopically extended until a desired length is reached, the rods being secured in place by tightening respective locking mechanisms as described above. Holding the body member 20 by the handle 28, the pet owner may walk the dog and avoid becoming entangled by the flexible leash 54 by keeping the dog at a respective distance. The dog will not be jerked back if he bolts ahead or to the side in that the reel 50 will automatically allow the reel 50 to unwind an additional length of the flexible leash 54. The pet owner is also protected from being jerked ahead or side to side by an active pet. The dog, however, is gently restrained by the tension adjustment mechanism 60 which may be tightened or loosened by the user, depending the size or aggression of the dog. This restraint or tension keeps a dog from bolting and extending the flexible leash 54 too quickly.

It is understood that while certain forms of this invention have been illustrated and described, it is not limited thereto except insofar as such limitations are included in the following claims and allowable functional equivalents thereof.

1. A rigid pet leash for use in walking a pet such as a dog, comprising:
a body member having first and second ends, said body member having a rigid construction and a tubular configuration defining an interior area;
a tubular first extension rod situated in said body member interior area and movable through said body member second end between a retracted configuration substantially inside said interior area and an extended configuration substantially outside said interior area, said first extension rod having a generally rigid construction and a distal end defining an outlet;
a locking mechanism positioned adjacent said body member second end configured to selectively hold said first extension rod at said retracted or extended configuration;
a retractable reel positioned in said body member interior area and configured for rotatable movement;
a flexible leash wound about said reel and extending through said body member interior area and through said first extension rod to said outlet,
a retraction input positioned on said body member operatively connected to said reel and configured to selectively retract said leash about said reel;
a tension adjustment mechanism situated in said body member interior area in operative communication with said leash and configured to selectively increase a tension on said leash when said leash is unwound from said reel; and
a tension adjustment mechanism input positioned on said body member operatively connected to said adjustment mechanism and configured to actuate said adjustment mechanism.

2. The pet leash as in claim 2, wherein said tension adjustment mechanism includes:
a retaining member coupled to said tension adjustment mechanism input and configured to extend into said body member interior space, said retaining member being operatively coupled to said leash;
wherein movement of said tension adjustment mechanism input to a first configuration causes said retaining member to move to a tightened configuration at which said leash is biased away from a linear configuration;
wherein movement of said tension adjustment mechanism input to a second configuration causes said retaining member to move to a released configuration at which said leash is returned to said linear configuration.

3. The pet leash as in claim 2, wherein:
said body member includes a wall positioned between said reel and said retaining member, said wall defining a bore; and
said leash extending through said bore.

4. The pet leash as in claim 3, wherein said leash is in frictional contact with said wall when positioned in said bore, said frictional engagement being increased when said retaining member is at said tightened configuration.

5. The pet leash as in claim 4, wherein said tension adjustment mechanism input is a rotary dial, a respective rotation of said dial causing respective linear movement of said retaining member between said tightened and said released configurations.

6. The pet leash as in claim 1, wherein said first extension rod is telescopically coupled to said base portion.

7. The pet leash as in claim 1, further comprising:
a second extension rod situated in said first extension rod and movable through an open distal end of said first extension rod between a retracted configuration substantially inside said first extension rod and an extended configuration substantially outside said first extension rod, said second extension rod having a generally rigid construction and defining a second extension rod outlet at a distal end thereof; and
an auxiliary locking mechanism positioned adjacent said first extension rod distal end configured to selectively hold said second extension rod at said retracted or extended configuration.

8. The pet leash as in claim 7, wherein said auxiliary locking mechanism is a rotatable friction clamp.

9. The pet leash as in claim 1, wherein said locking mechanism is a rotatable friction clamp.

10. The pet leash as in claim 1, wherein said outlet includes a joint configured to receive said leash therethrough and to selectively swivel from side to side.

11. The pet leash as in claim 1, further comprising a handle coupled to said first end of said body member.

12. The pet leash as in claim 1, wherein said retraction input is a rotary dial.

13. The pet leash as in claim 4, further comprising:
a second extension rod situated in said first extension rod and movable through an open distal end of said first extension rod between a retracted configuration substantially inside said first extension rod and an extended configuration substantially outside said first extension rod, said second extension rod having a generally rigid construction and defining a second extension rod outlet at a distal end thereof; and
an auxiliary locking mechanism positioned adjacent said first extension rod distal end configured to selectively hold said second extension rod at said retracted or extended configuration.
